(19) United States
(12) Patent Application Publication
(10) Pub. No.: US 2025/0190781 A1
(43) Pub. Date: Jun. 12, 2025

(54) DETERMINING WHEN A TECHNICAL SUPPORT SYSTEM IS TO RESPOND IN A MULTI-PARTY CONVERSATION

(71) Applicant: Cisco Technology, Inc., San Jose, CA (US)

(72) Inventors: David C. White, JR., St. Petersburg, FL (US); Mohammed Izzat Hamzeh, Woluwe-Saint-Lambert (BE)

(21) Appl. No.: 18/533,370

(22) Filed: Dec. 8, 2023

(51) Int. Cl. G06N 3/08

(52) U.S. Cl. CPC G06N 3/08

(57) ABSTRACT

A technical support system obtains a communication addressed to the technical support system and at least one other recipient and transmits first information associated with the communication to a first Large Language Model (LLM) to determine whether the technical support system is to respond to the communication. In response to determining that the technical support system is to respond to the communication, the technical support system transmits second information associated with the communication to a second LLM with a request to generate a response to the communication and transmits the response to the communication.

### TECHNICAL FIELD

The present disclosure relates to technical support systems.

### BACKGROUND

A technical support system with a software emulated “humanoid” engineer may work on thousands of cases simultaneously. The humanoid involves oversight to ensure accuracy when interacting with technology users. One challenge faced by technical support services is determining when the humanoid is to respond to a communication associated with an issue when multiple parties are involved in a conversation about with the issue.

### BRIEF DESCRIPTION OF THE DRAWINGS

FIG. 1 is a block diagram of a technical support system configured to determine whether to respond to a multi-party communication received from a user device, according to an example embodiment.

FIG. 2 shows an exemplary electronic communication that may be received at the technical support system, according to an example embodiment.

FIG. 3 is a diagram illustrating leveraging an instruct-based large language model (LLM) to determine whether the technical support system should respond to the electronic communication, according to an example embodiment.

FIG. 4 is a diagram illustrating leveraging a generative-based LLM to determine how to respond to the electronic communication, according to an example embodiment.

FIG. 5 is a flow diagram illustrating a method of determining whether to respond to a multi-party communication and how to respond to the multi-party communication, according to an example embodiment.

FIG. 6 is a flow diagram illustrating another method of determining whether to respond to a multi-party communication and how to respond to the multi-party communication, according to an example embodiment.

FIG. 7 is a hardware diagram of a computer device that may be configured to perform the technical support system features involved in determining whether to respond to a multi-party communication and responding to the multi-party communication, according to an example embodiment.

### DETAILED DESCRIPTION

### Overview

In one embodiment, a method is provided for responding to a technical support communication that is addressed to a technical support system and at least one other recipient. The method includes obtaining, by a technical support system, a communication addressed to the technical support system and at least one other recipient. The method involves transmitting first information associated with the communication to a first Large Language Model (LLM) to determine whether the technical support system is to respond to the communication. In response to determining that the technical support system is to respond to the communication, the method involves transmitting second information associated with the communication to a second LLM with a request to generate a response to the communication. The method then involves transmitting the response to the communication.

### Example Embodiments

Automated or virtual technical support services are frequently used to address technical support issues. A technology user may transmit an electronic communication to the technical support service and a software emulated “humanoid” process of the technical support service may communicate with the user and perform actions to address the support issue. The humanoid may communicate with the user as a human would to, for example, gather additional information or respond to questions raised by the user. The humanoid includes a computer executed process for mimicking human dialog. In other words, the humanoid process software includes software, which when executed by a computer processor, can mimic human dialog.

The humanoid can monitor electronic communications in a conversation involving the humanoid and at least one other party. For example, each other party can be a person, machine, or computer executed process (e.g., a humanoid). The humanoid can model the electronic communications by uniquely identifying each of the electronic communications and storing information associated with each electronic communication in a database. In addition to communicating with a user, the humanoid identifies technical support issues in electronic communications and performs actions to address the technical support issues.

When an electronic communication is addressed only to the technical support service, it is easy to know that the technical support service should perform an action with respect to the communication (e.g., respond to the communication, attempt to resolve an issue described in the communication, etc.). However, it is more difficult to determine whether the technical support service should perform an action with respect to an electronic communication when the electronic communication is addressed to the technical support service and at least one other recipient. For example, a user may address an electronic communication to the technical support service as well as parties at the user's end, a representative of a company associated with the technical support service, an on-site vendor, or another party. When multiple parties are involved in a conversation, it is difficult for the technical support service to determine whether to perform an action when a communication addressed to multiple recipients is received.

Currently, human oversight is involved to ensure that everything the technical support service does and says is accurate. Humans have intuition and can understand when a message is tagged to them (or multiple people that includes them) even if they are not directly addressed in the message. Additionally, humans are able to acknowledge the sender of the electronic communication, as well as potentially other recipients of the communication. Currently, humans may monitor the communications received at the technical support system to identify when a user is directing a response to the technical support service. Additionally, humans may keep track of outstanding items/requests that are needed from a user to progress a “case” forward and, when one of the items is received, a human knows to acknowledge receipt of the item (even if the technical support service is not directly mentioned in the communication). A technical support service may work on thousands of cases simultaneously. In order to scale exponentially instead of linearly, it is useful to remove human overwatch wherever possible.

Presented herein are techniques for determining if and when a technical support service is to respond in a multi-party conversation that is not addressed to the technical support service. Techniques described herein examine an incoming technical support issue communication that is addressed to multiple parties to determine whether the technical support system or a particular recipient is addressed in the communication. If no one is addressed in the communication, a pre-trained transformer large language model (LLM) is leveraged to assist in determining whether the technical support service needs to take an action or respond based on the content in the message and additional information. If the technical support service should respond, a generative LLM is leveraged to determine how to respond to the communication.

Thus, present embodiments improve the technical field of automated technical support by providing computer executed humanoid software that identifies when to respond to a multi-party communication in a multi-party conversation when the humanoid is not directly addressed in the communication. Present embodiments therefore increase the efficiency of automated technical support services by eliminating or minimizing human oversight when addressing technical support issues. Thus, present embodiments provide the practical application of a technical support system that identifies when to respond to a multi-party communication, identifies a technical support issue from the multi-party communication, and performs actions to resolve the technical support issue without human intervention.

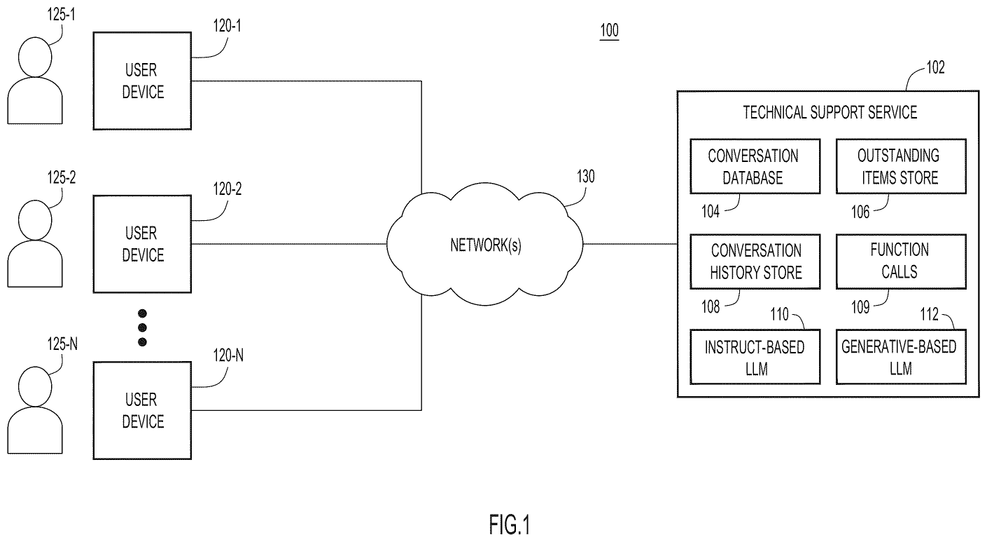

Reference is first made to FIG. 1. FIG. 1 shows a block diagram of a system 100 that is configured to determine whether a technical support system is to respond to a multi-party communication that is not specifically addressed to the technical support service and to determine how to respond the communication. The system 100 includes a technical support service 102 and a plurality of user devices 120-1, 120-2, . . . , 120-N that communicate with technical support service 102 via one or more networks 130. Each user device 120-1 to 120-N is associated with a user 125-1, 125-2, . . . , 125-N. The technical support service 102 includes a conversation database 104, an outstanding items store 106, a conversation history store 108, function calls 109, an instruct-based LLM 110, and a generative-based LLM 112.

The technical support service 102 includes a plurality of devices (e.g., processors, controllers, data storage devices, etc.) configured to communicate with users 125-1 to 125-N of user devices 120-1 to 120-N as a human would and perform actions to address technical support issues described in electronic communications received from the users of user devices 120-1 to 120-N. The technical support service 102 may receive an electronic communication from a user that includes information outlining a technical support issue. The technical support service 102 includes a humanoid that has been trained (e.g., using machine learning) to communicate with the user to gather information and respond to questions in a manner such that the user may be unable to distinguish between communicating with the humanoid and communicating with a human, such as a technical assistance center engineer. The technical support service 102 is additionally trained to resolve the technical support issues. The technical support service 102 may use machine learning models to address and resolve technical support issues. Based on the information received from one or more users, technical support service 102 is able to diagnose issues, perform actions to resolve issues, and communicate with users in a manner consistent with that of a human.

Each of user devices 120-1 to 120-N may be a tablet, laptop computer, desktop computer, Smartphone, virtual desktop client, virtual whiteboard, or any user device now known or hereinafter developed. User devices 120-1 to 120-N may have a dedicated physical keyboard or touch-screen capabilities to provide a virtual on-screen keyboard to enter text. User devices 120-1 to 120-N have the capability to send and receive electronic communications (e.g., emails, chats, messaging communications received via a messaging application or messaging web-service, etc.). For example, users 125-1 to 125-N may use user devices 120-1 to 120-N to send electronic communications (e.g., associated with a technical support issue) to and receive electronic communications from technical support service 102.

In the example illustrated in FIG. 1, a user 125-1 of user device 120-1 may transmit an electronic communication to technical support service 102 with information about a technical support issue that needs to be resolved. The user 125-1 may additionally send the electronic communication to a user 125-2 of user device 120-2 and a user 125-N of user device 120-N. For example, the electronic communication may be an email addressed to the email addresses of the technical support service 102, the user 125-2, and the user 125-N. As another example, the user 125-1 may send a message in a messaging or chat space in a messaging application or web-service and include the technical support service 102, the user 125-2, and the user 125-N in the messaging/chat space.

Technical support service 102 may receive the electronic communication and may update a conversation database 104 with information associated with the communication. Conversation database 104 may store information associated with each communication received at technical support service 102 and may be used by technical support service 102 to determine whether to respond to communications, identify the participants in conversations, identify a user contact for the conversations, follow the conversations among different participants, etc. Technical support service 102 may update the conversation database 104 with an indication of the sender of the communication (e.g., the user 125-1), indications of the recipients of the communication (e.g., technical support service 102, the user 125-2, and the user 125-N), an identifier associated with the communication, an identifier associated with a conversation associated with the communication, information about the substance of the email, and additional information. Technical support service 102 may additionally update a pointer in the conversation database 104 to indicate a target of the most recent communication in the conversation.

Technical support service 102 may identify that the communication is a multi-party communication. For example, when the communication is an email, technical support service 102 may extract email addresses in the TO and CC fields of the email and, if more than one email address is detected, technical support service 102 may identify that the communication is a multi-party communication. In this example, technical support service 102 may filter out known addresses associated with the technical support service 102 to identify that the email is addressed to multiple parties and not to multiple email addresses associated with the technical support service 102. If the communication is a message in a message/chat space, technical support service 102 may identify that more than one recipient has been added to the message/chat space and may identify the communication as a multi-party communication. Technical support service 102 may set a field in conversation database 104 indicating that the communication is part of a multi-party conversation.

After determining that the communication is part of a multi-party conversation, technical support service 102 examines the communication to determine whether the communication is addressed to the technical support service 102. If the communication is addressed to the technical support service 102, then the technical support service 102 will perform an action with respect to the communication (e.g., respond to the communication, perform an action to address the issue described in the communication, etc.). If the communication is addressed to another recipient or user, technical support service 102 may not need to respond or take action.

To determine whether the communication is addressed to the technical support service 102, the technical support service 102 examines a greeting of the communication to see if a recipient of the communication is directly mentioned. For example, if the communication is an email, technical support service 102 may examine the greeting of the email to determine whether the greeting mentions a name of someone listed in the TO or the CC line of the email. If no recipient is directly addressed in the greeting, technical support service 102 may examine the body of the email to see if someone from the TO or CC line is addressed (either directly or @<name>). If the communication is a message in a message space, technical support service 102 may examine the message to see if a participant of the message space is addressed (either directly or @<name>).

If no recipient is addressed in the communication, an instruct-based LLM 110 is leveraged to assist in determining whether the technical support service 102 is to respond to the communication based on the content in the communication. Instruct-based LLM 110 is a pre-trained transformer LLM that is used as a zero-shot binary classifier. For the system prompt, instruct-based LLM 110 is instructed that it is to act as a binary classifier and determine whether the technical support service 102 should respond to the communication. To make the decision, the instruct-based LLM 110 is provided the past cleansed conversation history associated with the communication, outstanding items/requests needed from one or more users to resolve the technical support issue, and the current communication.

The past conversation history includes a history of communications in a conversation associated with the communication. For example, the communication may be just one communication in a history of communications that make up a conversation. As discussed above, the conversation may be associated with an identifier that is stored in conversation database 104. Technical support service 102 may determine that a communication is part of a conversation based on, for example, a subject of the email (when the communication is an email), a particular reference number associated with the communication and other communications in the conversation, the content of the communication, the recipients of the communication, etc. The past conversation history is cleansed to remove information that is not pertinent to resolving the technical issue (e.g., greetings, salutations, headers, sign-offs, etc.). The past cleansed conversation history that is transmitted to the instruct-based LLM 110 includes information associated with the senders of the communications and the recipients of the communications.

The outstanding items/requests include information that the technical support service 102 needs from one or more of the users to complete a task or resolve an issue. The outstanding items/requests may have been determined prior to the technical support service 102 receiving the electronic communication. The list of outstanding items may be stored in the outstanding items store 106. For example, if technical support service 102 needs a serial number or a log output to resolve a support issue from a conversation, technical support service 102 may store an indication of these items in the outstanding items store 106 with an identifier associated with the conversation or the issue being resolved. Technical support service 102 may obtain the list of the needed items/requests from the outstanding items store 106 and transmit the list to the instruct-based LLM 110.

Technical support service 102 may additionally cleanse the current communication and transmit the cleansed current communication to the instruct-based LLM 110. Instruct-based LLM 110 receives the system prompt to act as a binary classifier as well as the past-cleansed conversation history, outstanding items/requests, and the current communication and responds with an indication as to whether the technical support service 102 is to respond to the communication. In the example illustrated in FIG. 1, instruct-based LLM 110 returns an indication that the technical support service 102 needs to respond to the communication.

Once it has been determined that the technical support service 102 needs to respond to the communication, technical support service 102 determines how to respond. At this point, technical support service 102 may take an action (which may complete an outstanding items) and/or respond to the communication with text. A generative-based LLM 112 is leveraged to determine how to respond to the communication. Technical support service 102 transmits to generative-based LLM 112 the cleansed current communication, the past cleansed conversation history, and a list of function calls that generative-based LLM 112 can execute to generate the response.

As illustrated in FIG. 1, function calls 109 store a number of function calls that may be executed by generative-based LLM 112 to generate responses. The function calls 109 may provide guidance as to actions the generative-based LLM 112 can take and how to take the actions. Different function calls may be executed in different situations and based on different technical support issues. For example, a function call may include an application programming interface (API) call used to fill out a return merchandise authorization (RMA), provision a license for a product, generate a license for a product, analyze crash actions/perform debugging, perform software upgrades, schedule a standby for a maintenance window, or perform other function calls depending upon the type of technical support issue outlined in the communication. Technical support service 102 may identify the functions that may be leveraged for the particular technical support issue described in the communication and provide the function calls to generative-based LLM 112. Generative-based LLM 112 may be prompted to leverage the functions provided to complete any outstanding tasks and return the result (if a function was called). Generative-based LLM 112 may leverage the provided functions, complete any outstanding tasks (if applicable), and return a response to the communication.

When technical support service 102 receives the response to the communication, technical support service 102 sends the response to the sender of the communication, a user contact associated with the conversation, and any other pertinent participants associated with the communication (e.g., the participants in the TO and CC fields and any other participants associated with the conversation). Technical support service 102 additionally updates the conversation database 104 with information from the response, checks off any outstanding actions that were completed in outstanding items store 106, and updates the pointer in the conversation database 104 to indicate the target of the most recent communication in the conversation.

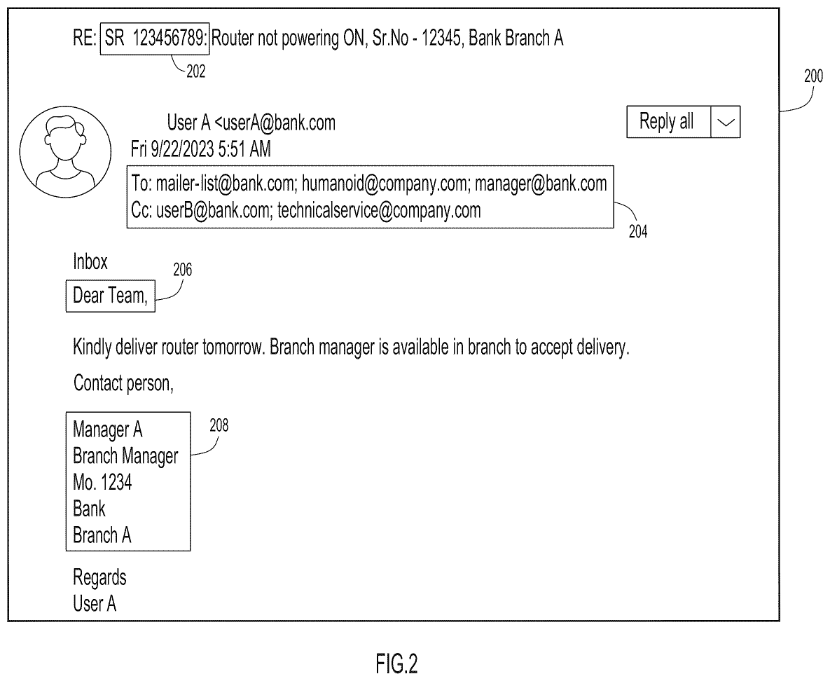

Reference is now made to FIG. 2. FIG. 2 illustrates an example communication 200 that may be received at technical support service 102. More specifically, communication 200 is an email received from User A. The subject of the email is “RE: SR 123456789: Router not powering ON, Sr. No—12345, Bank Branch A.” As shown at 202, based on the subject, technical support service 102 may identify the communication 200 as being associated with service request (SR) number 123456789. Therefore, technical support service 102 may determine that communication 200 is associated with a conversation consisting of communications about the service request 123456789.

Communication 200 includes a list 204 of recipients of the email in the TO and CC fields (e.g., mailer-list@bank.com, humanoid@company.com, manager@bank.com, userB@bank.com, and technicalservice@company.com) and a greeting 206 that says “Dear Team.” The body of communication 200 says “Kindly deliver router tomorrow. Branch manager is available in branch to accept delivery” and, as shown at 208, the email includes a contact name for the branch manager (e.g., Manager A) and an address for delivery of the router (e.g., Mo. 1234, Bank, Branch A). In this example, the contact name and address are on the list of outstanding items needed to address the technical issue associated with service request 123456789.

Technical support service 102 may update conversation database 104 with information associated with communication 200. For example, technical support service 102 may add an entry to conversation database 104 with an identifier for communication 200, an identifier for the conversation associated with service request 123456789, information about the sender of communication 200 (e.g., User A), information about the recipients of communication 200 from list 204, and additional information. In this example, the email address humanoid@company.com is associated with support technical service 102. The email address technicalservice@company.com may additionally be associated with technical support service 102 or another entity associated with the technical support service 102.

After receiving communication 200, technical support service 102 determines whether the technical support service 102 should respond to the email. More specifically, technical support service 102 first examines the TO and CC lines to determine whether the communication 200 is a multi-party communication. As illustrated by list 204, communication 200 is addressed to multiple recipients. Technical support service 102 may set a field in conversation database 104 indicating that communication 200 is part of a multi-party conversation. Since communication 200 is addressed to more than one recipient, technical support service 102 next examines the greeting to determine whether a particular recipient is mentioned. Greeting 206 says “Dear Team,” which does not address any address any particular recipient. The body of the email additionally does not address any particular recipient.

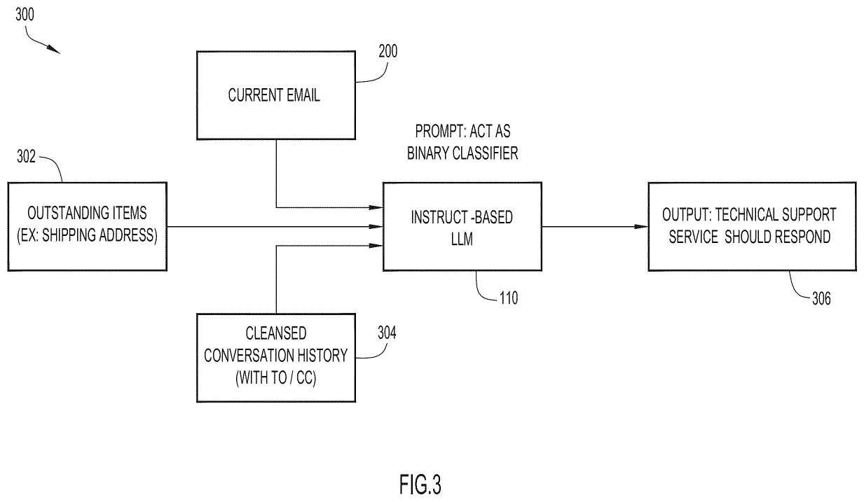

Since technical support service 102 is unable to determine whether to respond to the communication 200 based on the recipient list 204, the greeting 206, or the body of the email, technical support service 102 utilizes instruct-based LLM 110 to determine whether to respond to the communication 200. Reference is now made to FIG. 3. FIG. 3 is a diagram illustrating an example 300 in which technical support service 102 leverages instruct-based LLM 110 to determine whether to respond to communication 200.

As illustrated in FIG. 3, technical support service 102 transmits to instruct-based LLM 110 the communication 200, a list of outstanding items 302, and the cleansed conversation history 304 with a prompt to act as a binary classifier (e.g., respond with whether or not technical support service 102 should respond to communication 200). The list of outstanding items 302 is stored at outstanding items store 106 and the cleansed conversation history 304 is stored at conversation history store 108. In this example, the list of outstanding items 302 includes the name of the contact person and the shipping address shown at 208. Since the communication 200 includes information needed by technical support service 102 to complete a task on the list of outstanding items, instruct-based LLM 110 returns an output 306 indicating that technical support service 102 needs to respond to the communication 200.

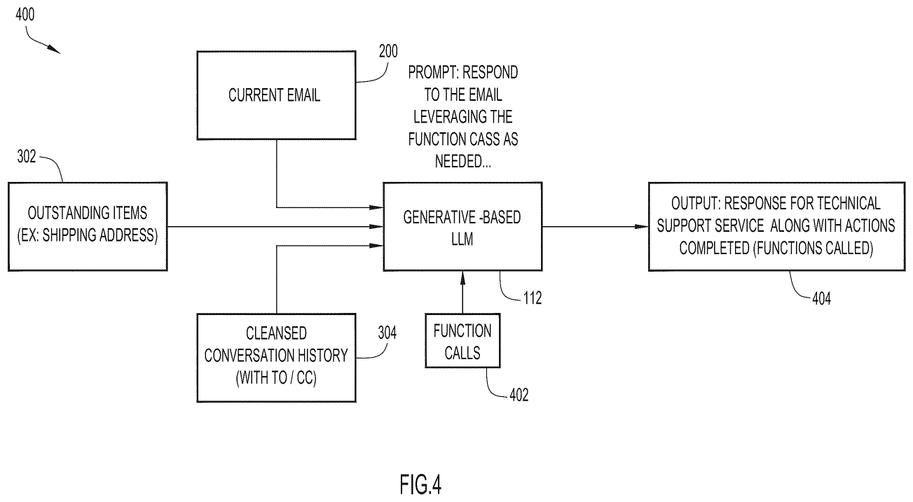

After determining that technical support service 102 is to respond to the communication 200, technical support service 102 next determines how to respond to the communication 200. Reference is now made to FIG. 4. FIG. 4 illustrates an example 400 in which technical support service 102 leverages generative-based LLM 112 to generate a response to communication 200.

As illustrated in FIG. 4, technical support service 102 transmits to generative-based LLM 112 the communication 200, the list of outstanding items 302 (e.g., the contact name and shipping address), the cleansed conversation history 304, and a list of function calls 402 that generative-based LLM 112 can call to complete actions. Technical support service 102 additionally provides a prompt providing context for generative-based LLM 112 regarding its role and the objective. For example, the prompt may indicate that the objective is to respond to the email leveraging the function calls as needed. In this example, the list of function calls 402 may include a function call to create a return merchandise authorization (RMA) for delivery of the router.

Referring back to FIG. 3, based on the list of outstanding items 302 and the cleansed conversation history 304, generative-based LLM 112 determines that the shipping address and contact information were needed to complete the task associated with the conversation. Generative-based LLM 112 extracts the shipping address and contact information from communication 200 and leverages the function call to create an RMA for delivery using the shipping address and contact information. Generative-based LLM 112 additionally generates a response email to the communication 200 to indicate that the RMA was created and provide the RMA number to the users. Generative-based LLM 112 provides output 404 that includes the response email along with a list of actions completed (and possibly functions called).

Technical support service 102 consults conversation database 104 to ensure the right parties are copied on the response email (e.g., the recipients that were copied on communication 200 and/or other communications in the conversation) while responding directly to both the user contact associated with the conversation and the sender of the last message (e.g., User A). Both the user contact and User A are added to the TO line of the response email and directly addressed in the greeting. Technical support service 102 sends the response email with the RMA number to the recipients. Technical support service 102 additionally updates the list of outstanding items 302 and the conversation database 104. For example, technical support service 102 updates the list of outstanding items 302 to indicate that the contact information and shipping address have been received and are no longer outstanding items. Technical support service 102 updates the conversation database 104 with information associated with the response email (e.g., communication identifier, conversation identifier, information associated with recipients, pointer to as to whom the last message targeted, etc.).

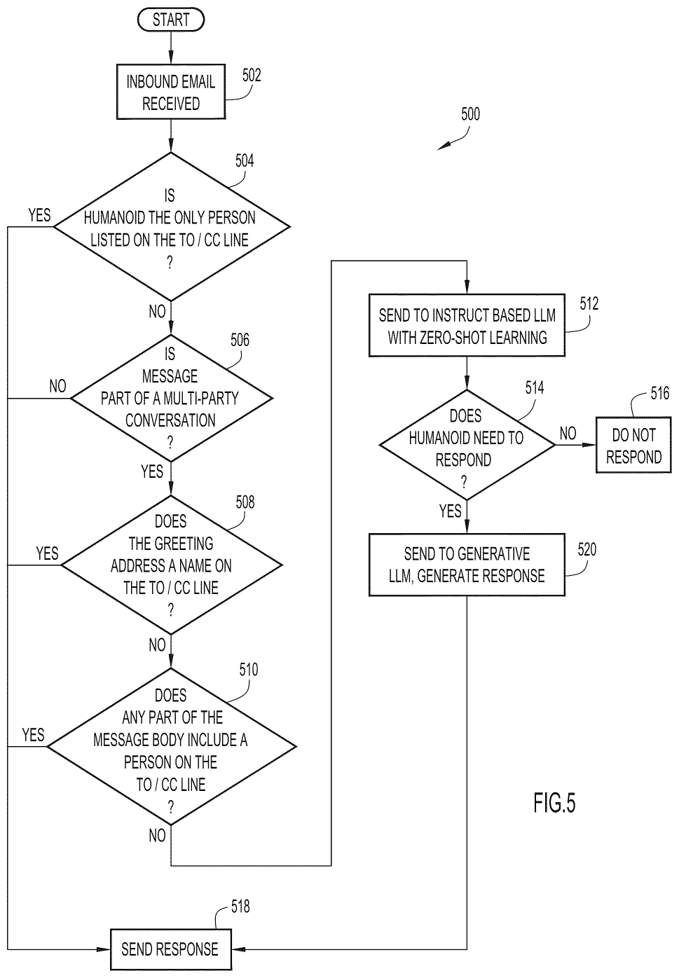

Reference is now made to FIG. 5, with continued reference to FIG. 1. FIG. 5 is a flow chart illustrating a method 500 for determining whether technical support service 102 needs to respond to a multi-party communication. At 502, an inbound email or other electronic communication is received at technical support service 102. At 504, the technical support service 102 determines whether the humanoid/technical support service 102 is the only recipient listed on the TO or CC lines of the email. If the humanoid is the only recipient listed, at 518, the technical support service 102 responds to the email.

If the humanoid is not the only recipient listed, at 506, technical support service 102 determines whether the message is part of a multi-party conversation. If the message is not part of a multi-party conversation, processing continues to 518 and the technical support service 102 responds to the communication. If the message is part of a multi-party conversation, at 508, technical support service 102 determines whether the greeting addresses a name of a recipient from the TO or CC lines. If the greeting addresses the humanoid, at 518, the technical support service 102 responds to the message. If the greeting addresses a different recipient on the TO or CC line, technical support service 102 may not respond to the message.

If no particular recipient is mentioned in the greeting, at 510, technical support service 102 determines whether any part of the message body includes a direct reference to a recipient on the TO or CC lines of the email. If the message body addresses the humanoid, at 518, the technical support service 102 responds to the message. If the message body addresses a different recipient on the TO or CC lines, technical support service 102 may not respond to the message. If the message body does not directly mention a recipient in the TO or CC lines of the email, at 512, technical support service 102 sends the communication to instruct-based LLM 110 along with a list of outstanding items/tasks, the cleansed conversation history, and a prompt to provide a binary response as to whether the humanoid should respond to the communication.

At 514, technical support service 102 receives an indication from instruct-based LLM 110 as to whether the humanoid needs to respond to the communication. If the humanoid does not need to respond, at 516, technical support service 102 does not respond. If the humanoid does need to respond, at 520, technical support service 102 sends the communication to generative-based LLM 112 along with the list of outstanding items/tasks, the cleansed conversation history, function calls the generative-based LLM 112 can call to complete any tasks, and a prompt providing context, a role of the generative-based LLM 112, and an objective.

The generative-based LLM 112 completes any necessary tasks (e.g., by leveraging the supplied function calls) and generates a response to the communication. At 518, technical support service 102 sends the response to the communication to the sender of the communication, a case contact for a conversation associated with the communication, and any other pertinent recipients (e.g., based on consulting the conversation database 104).

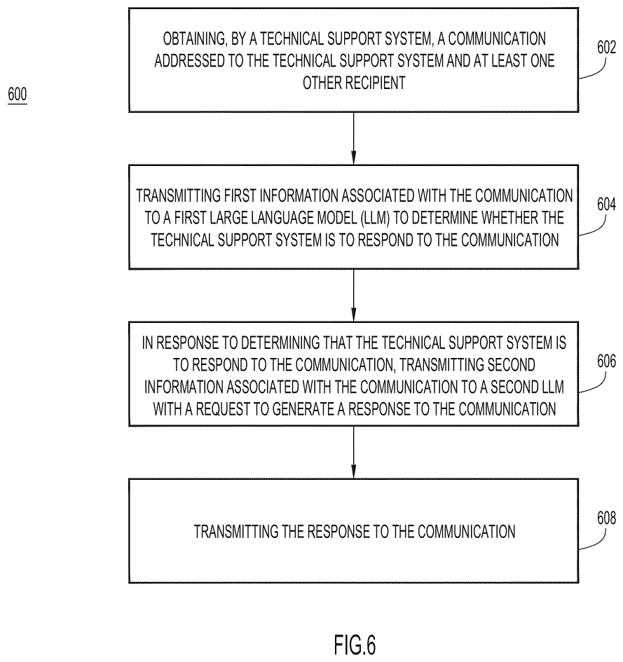

Reference is now made to FIG. 6. FIG. 6 is a flow diagram illustrating a method 600 of generating and transmitting a response to a multi-party communication. At 602, a technical support system obtains a communication addressed to the technical support system and at least one other recipient. For example, technical support service 102 may receive an email addressed to multiple recipient or may receive a message in a message space that includes multiple participants.

At 604, first information associated with the communication is transmitted to a first LLM to determine whether the technical support system is to respond to the communication. For example, technical support service 102 may transmit to instruct-based LLM 110 the communication, a cleansed conversation history associated with the communication, and a list of outstanding items needed from one or more users associated with the communication to complete a task. Technical support service 102 may additionally transmit a prompt to instruct-based LLM 110 indicating that instruct-based LLM 110 is to return a binary response as to whether technical support service 102 is to respond to the communication.

At 606, in response to determining that the technical support service is to respond to the communication, second information associated with the communication is transmitted to a second LLM with a request to generate a response to the communication. For example, technical support service 102 may transmit to generative-based LLM 112 the communication, a cleansed conversation history associated with the communication, the list of outstanding items needed to complete a task, and one or more function calls for completing a task associated with the communication. Technical support service 102 may additionally transmit a prompt to generative-based LLM 112 indicating that generative-based LLM 112 is to complete any outstanding tasks using the function calls and generate a response to the communication.

At 608, a response to the communication is transmitted. For example, technical support service 102 receives the response from generative-based LLM 112 and consults the conversation database 104 to determine which recipients should receive the response. Technical support service 102 transmits the response to a case contact associated with the communication, the sender of the communication, and any other pertinent recipients.

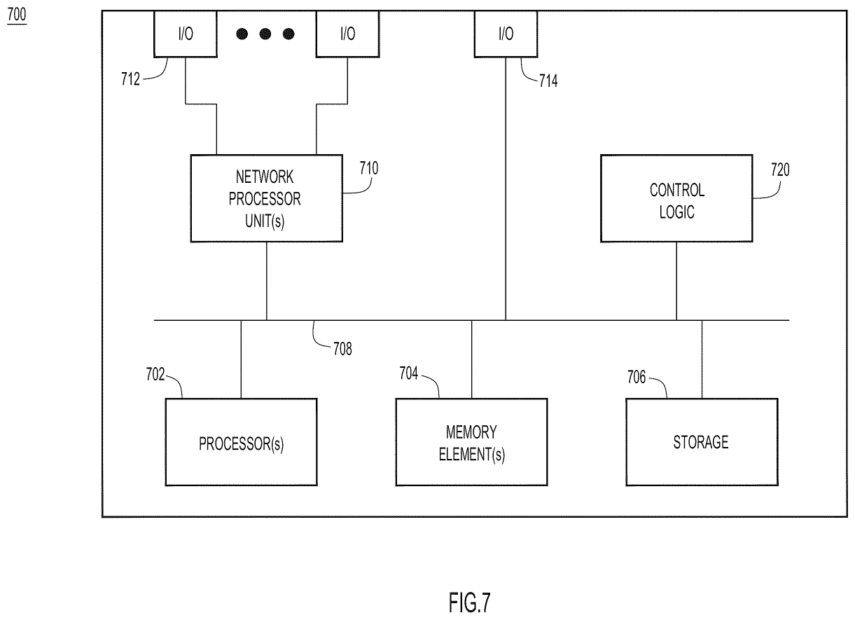

Referring to FIG. 7, FIG. 7 illustrates a hardware block diagram of a computing/computer device 700 that may perform functions of a device associated with operations discussed herein in connection with the techniques depicted in FIGS. 1-6. In various embodiments, a computing device, such as computing device 700 or any combination of computing devices 700, may be configured as any devices as discussed for the techniques depicted in connection with FIGS. 1-6 in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, mouse, display, a touch screen display, and/or any other suitable input and/or output device now known or hereafter developed. These user input devices may be used by a user to initiate a monitoring session and to specify where the results of the monitoring session are to be delivered, as described above. This may be the case, in particular, when the computing device 700 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, particularly when the computing device 700 serves as a user device as described herein.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to conduct operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a method is provided that includes obtaining, by a technical support system, a communication addressed to the technical support system and at least one other recipient; transmitting first information associated with the communication to a first Large Language Model (LLM) to determine whether the technical support system is to respond to the communication; in response to determining that the technical support system is to respond to the communication, transmitting second information associated with the communication to a second LLM with a request to generate a response to the communication; and transmitting the response to the communication.

In one example, the method further includes prior to obtaining the communication, identifying, from a conversation history associated with the communication, outstanding items needed from one or more users associated with the communication to complete a request associated with the communication; and storing a list of the outstanding items. In another example, the method further includes updating the list of the outstanding items based on the communication or the response to the communication.

In another example, the first information includes the conversation history associated with the communication, the list of the outstanding items, and the communication. In another example, the second information includes the conversation history associated with the communication, the list of the outstanding items, the communication, and functions calls for the second LLM to execute to generate the response. In another example, the first LLM is an instruct-based transformer LLM and the second LLM is a generative LLM. In another example, the method further includes updating a conversation database with information associated with the communication or the response.

In another form, an apparatus of a technical support system is provided that includes: a memory; a network interface configured to enable network communication; and a processor, wherein the processor is configured to perform operations including: obtaining a communication addressed to the technical support system and at least one other recipient; transmitting first information associated with the communication to a first Large Language Model (LLM) to determine whether the technical support system is to respond to the communication; in response to determining that the technical support system is to respond to the communication, transmitting second information associated with the communication to a second LLM with a request to generate a response to the communication; and transmitting the response to the communication.

In yet another form, one or more non-transitory computer readable storage media encoded with instructions are provided that, when executed by a processor of a technical support system, cause the processor to execute a method including obtaining a communication addressed to the technical support system and at least one other recipient; transmitting first information associated with the communication to a first Large Language Model (LLM) to determine whether the technical support system is to respond to the communication; in response to determining that the technical support system is to respond to the communication, transmitting second information associated with the communication to a second LLM with a request to generate a response to the communication; and transmitting the response to the communication.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by a technical support system, a communication addressed to the technical support system and at least one other recipient;
transmitting first information associated with the communication to a first Large Language Model (LLM) to determine whether the technical support system is to respond to the communication;
in response to determining that the technical support system is to respond to the communication, transmitting second information associated with the communication to a second LLM with a request to generate a response to the communication; and
transmitting the response to the communication.

2. The method of claim 1, further comprising:
prior to obtaining the communication, identifying, from a conversation history associated with the communication, outstanding items needed from one or more users associated with the communication to complete a request associated with the communication; and
storing a list of the outstanding items.

3. The method of claim 2, further comprising:
updating the list of the outstanding items based on the communication or the response to the communication.

4. The method of claim 2, wherein the first information includes the conversation history associated with the communication, the list of the outstanding items, and the communication.

5. The method of claim 2, wherein the second information includes the conversation history associated with the communication, the list of the outstanding items, the communication, and functions calls for the second LLM to execute to generate the response.

6. The method of claim 1, wherein the first LLM is an instruct-based transformer LLM and the second LLM is a generative LLM.

7. The method of claim 1, further comprising:
updating a conversation database with information associated with the communication or the response.

8. An apparatus of a technical support system comprising:
a memory;
a network interface configured to enable network communication; and
a processor, wherein the processor is configured to perform operations comprising:
obtaining a communication addressed to the technical support system and at least one other recipient;
transmitting first information associated with the communication to a first Large Language Model (LLM) to determine whether the technical support system is to respond to the communication;
in response to determining that the technical support system is to respond to the communication, transmitting second information associated with the communication to a second LLM with a request to generate a response to the communication; and
transmitting the response to the communication.

9. The apparatus of claim 8, wherein the processor is further configured to perform operations comprising:
prior to obtaining the communication, identifying, from a conversation history associated with the communication, outstanding items needed from one or more user associated with the communication to complete a request associated with the communication; and
storing a list of the outstanding items.

10. The apparatus of claim 9, wherein the processor is further configured to perform operations comprising:
updating the list of the outstanding items based on the communication or the response to the communication.

11. The apparatus of claim 9, wherein the first information includes the conversation history associated with the communication, the list of the outstanding items, and the communication.

12. The apparatus of claim 9, wherein the second information includes the conversation history associated with the communication, the list of the outstanding items, the communication, and functions calls for the second LLM to execute to generate the response.

13. The apparatus of claim 8, wherein the first LLM is an instruct-based transformer LLM and the second LLM is a generative LLM.

14. The apparatus of claim 8, wherein the processor is further configured to perform operations comprising:
updating a conversation database with information associated with the communication or the response.

15. One or more non-transitory computer readable storage media encoded with instructions that, when executed by a processor of a technical support system, cause the processor to execute a method comprising:
obtaining a communication addressed to the technical support system and at least one other recipient;
transmitting first information associated with the communication to a first Large Language Model (LLM) to determine whether the technical support system is to respond to the communication;
in response to determining that the technical support system is to respond to the communication, transmitting second information associated with the communication to a second LLM with a request to generate a response to the communication; and
transmitting the response to the communication.

16. The one or more non-transitory computer readable storage media of claim 15, wherein the method further comprises:
prior to obtaining the communication, identifying, from a conversation history associated with the communication, outstanding items needed from one or more users associated with the communication to complete a request associated with the communication; and
storing a list of the outstanding items.

17. The one or more non-transitory computer readable storage media of claim 16, wherein the method further comprises:
updating the list of the outstanding items based on the communication or the response to the communication.

18. The one or more non-transitory computer readable storage media of claim 16, wherein the first information includes the conversation history associated with the communication, the list of the outstanding items, and the communication.

19. The one or more non-transitory computer readable storage media of claim 16, wherein the second information includes the conversation history associated with the communication, the list of the outstanding items, the communication, and functions calls for the second LLM to execute to generate the response.

20. The one or more non-transitory computer readable storage media of claim 15, wherein the first LLM is an instruct-based transformer LLM and the second LLM is a generative LLM.
